(19) United States
(12) Patent Application Publication
(10) Pub. No.: US 2024/0211808 A1
(43) Pub. Date: Jun. 27, 2024

(54) LEARNING APPARATUS, LEARNING METHOD, AND PROGRAM

(71) Applicant: NEC Corporation, Tokyo (JP)

(72) Inventor: Junki MORI, Tokyo (JP)

(73) Assignee: NEC Corporation, Tokyo (JP)

(21) Appl. No.: 18/545,494

(22) Filed: Dec. 19, 2023

(30) Foreign Application Priority Data
Dec. 23, 2022 (JP) 2022-206890

(51) Int. Cl. G06N 20/00

(52) U.S. Cl. CPC G06N 20/00

(57) ABSTRACT

A learning apparatus according to the present disclosure includes: a first training data generating unit configured to generate first training data in which a vector including values of a plurality of elements output by inputting unlabeled training data to a pre-learned machine learning model is a target variable; a second training data generating unit configured to generate second training data in which the values of the elements of the vector that is the target variable of the first training data are set so that a difference in magnitude of value between at least some of the elements becomes larger; and a learning unit configured to generate a machine learning model by machine learning using the first training data and the second training data.

### INCORPORATION BY REFERENCE

This application is based upon and claims the benefit of priority from Japanese patent application No. 2022-206890, filed on Dec. 23, 2022, the disclosure of which is incorporated herein in its entirety by reference.

### TECHNICAL FIELD

The present disclosure relates to a learning apparatus, a learning method, and a program.

### BACKGROUND ART

A technique called distillation is known in the field of machine learning. Distillation, which is learning a new machine learning model again with the output of a once learned machine learning model as a target variable, is a technique for compressing a machine learning model. Patent Literature 1 describes that distillation has effects of not only compressing a machine learning model but also preventing overfitting in machine learning. Therefore, it is possible by using distillation to prevent a membership inference attack (MI attack) to extract secret information (e.g., customer information, trade secrets, etc.) having been used for learning from the learned parameters of machine learning against overfitting. An MI attack is an attack to predict whether or not certain data has been used for learning a target machine learning model. Patent Literature 1: Japanese Unexamined Patent Application Publication No. JP-A 2022-131601

However, there is a problem that although a final machine learning model learned by distillation is sufficiently tolerant to an MI attack, a machine learning model in the process of learning is overfitted and is vulnerable to an MI attack. This is because if an output obtained by inputting data into a machine learning model before distillation is used as a target variable at the time of distillation, learning mistakenly proceeds in the direction of the target variable in the original training data during learning before sufficient learning. Then, in a situation that a model in the process of learning is uploaded as appropriate, or in a situation that it may be accessed from the outside during learning, there is a risk that information having been used for learning will leak due to an MI attack against a machine learning model in the process of learning.

### SUMMARY OF THE INVENTION

Accordingly, an object of the present disclosure is to provide a learning apparatus, a learning method and a program that can solve the problem that information having been used for learning leaks.

A learning apparatus as an aspect of the present disclosure includes: a first training data generating unit configured to generate first training data in which a vector including values of a plurality of elements output by inputting unlabeled training data to a pre-learned machine learning model is a target variable: a second training data generating unit configured to generate second training data in which the values of the elements of the vector as the target variable of the first training data are set so that a difference in magnitude of value between at least some of the elements becomes larger: and a learning unit configured to generate a machine learning model by machine learning using the first training data and the second training data.

Further, a learning method as an aspect of the present disclosure includes: generating first training data with a vector as a target variable, the vector including values of a plurality of elements output by inputting unlabeled training data to a pre-learned machine learning model: generating second training data in which the values of the elements of the vector as the target variable of the first training data are set so that a difference in magnitude of value between at least some of the elements becomes larger; and generating a machine learning model by machine learning using the first training data and the second training data.

Further, a program as an aspect of the present disclosure includes instructions for causing a computer to execute processes to: generate first training data with a vector as a target variable, the vector including values of a plurality of elements output by inputting unlabeled training data to a pre-learned machine learning model: generate second training data in which the values of the elements of the vector as the target variable of the first training data are set so that a difference in magnitude of value between at least some of the elements becomes larger; and generate a machine learning model by machine learning using the first training data and the second training data.

With the configurations as described above, the present disclosure enables inhibition of leakage of information having been used for learning.

### BRIEF DESCRIPTION OF DRAWINGS

FIG. 1 is a block diagram showing the configuration of a learning system in a first example embodiment of the present disclosure;

FIG. 2 is a view depicting processing by a learning apparatus disclosed in FIG. 1;

FIG. 3 is a view depicting processing by the learning apparatus disclosed in FIG. 1;

FIG. 4 is a flowchart showing the operation of the learning apparatus disclosed in FIG. 1;

FIG. 5 is a block diagram showing the hardware configuration of a learning apparatus in a second example embodiment of the present disclosure; and

FIG. 6 is a block diagram showing the configuration of the learning apparatus in the second example embodiment of the present disclosure.

### EXAMPLE EMBODIMENT

### First Example Embodiment

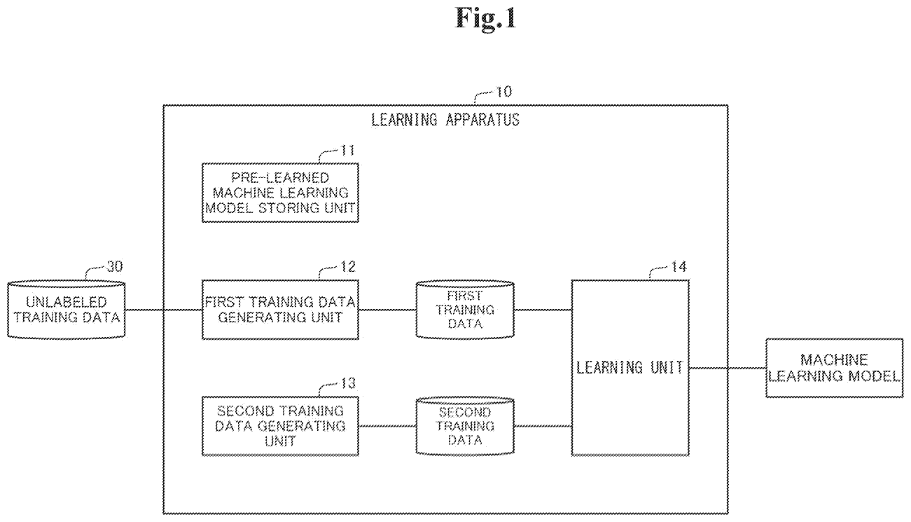

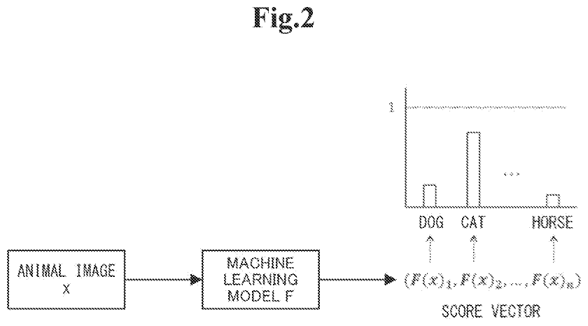

A first example embodiment of the present disclosure will be described with reference to FIGS. 1 to 4. FIG. 1 is a view for describing the configuration of a learning system, and FIGS. 2 to 4 are views for describing processing operation of the learning system.

### [Configuration]

The learning system in this example embodiment performs machine learning by using training data and generates a machine learning model. In this example embodiment, for example, the learning system generates a machine learning model that classifies input data into preset classifications. Meanwhile, the learning system may generate a machine learning model that performs any inference on input data.

FIG. 1 is a block diagram showing the configuration of a machine learning system including a learning apparatus 10. The learning apparatus 10 is configured by one or a plurality of information processing apparatuses each including an arithmetic logic unit and a memory unit. Then, as shown in FIG. 1, the learning apparatus 10 includes a pre-learned machine learning model storing unit 11, a first training data generating unit 12, a second training data generating unit 13, and a learning unit 14. The pre-learned machine learning model storing unit 11 is configured by the memory unit, and the first training data generating unit 12, the second training data generating unit 13, and the learning unit 14 can be realized by execution of a program for realizing the respective functions stored in the memory unit by the arithmetic logic unit. Moreover, a storing unit 30 that stores prepared unlabeled training data used for machine learning of a machine learning model is connected to the learning apparatus 10. Hereinafter, the respective components will be described.

The pre-learned machine learning model storing unit 11 stores a learned machine learning model as a machine learning model learned by a certain machine learning method in advance. Herein, a machine learning model is a machine learning model that makes inference for input data. That is to say, a machine learning model outputs the result of inference when making inference based on input data. For example, a machine learning model can be a classifier that performs image classification. In this case, a machine learning model outputs a score vector indicating a probability corresponding to each class. As an example, assuming a machine learning model is a function F, a score vector for input data x is F(x)=(F(x)₁, F(x)₂, . . . , F(x)ₙ), where n is the number of classes in a classification problem.

FIG. 2 shows an example of inference by a machine learning model. This figure illustrates an image-based animal classification problem, and shows a conceptual diagram of a score vector inferred by a machine learning model. Specifically, with an animal image x used as input data and an animal type used as a classification, a machine learning model infers the probability of classification into each animal type corresponding to the input animal image x, as a score vector. For example, F(x)₁ in FIG. 2 represents the probability that the image x is an image of “dog”.

A learning method of the pre-learned machine learning model stored in the pre-learned machine learning model storing unit 11 may be any method, and a plurality of pre-learned machine learning models may be stored. Training data used for the learning of the pre-learned machine learning model will be referred to as pre-training data. The pre-training data is a data group including a plurality of data, and labeled training data or unlabeled training data is used. Labeled training data is a collection of data with correct answer labels (teaching data) used for performing supervised learning, and is composed of a plurality of input data (explanatory variables) and correct answer labels (target variables) associated with the respective input data. Unlabeled training data is data composed of explanatory variables alone. In a case where the pre-training data is labeled training data, data different from the unlabeled training data stored in the storing unit 30 connected to the learning apparatus 10 may be used, or data obtained by assigning correct answer labels to the unlabeled training data stored in the storing unit 30 may be used.

There is a problem that the learned machine learning model may be subject to a Membership Inference attack (MI attack) as described above. An MI attack is an attack to infer whether or not target data has been used for learning by using the difference between score vectors for data having been used for learning and for data having not been used for learning. There is a risk of leakage of information on training data. For example, suppose a certain company has used customer data of the company to learn a machine learning model. If an attacker can access the machine learning model and infer that the data of a person owned by the company has been used for learning the machine learning model, the person will be found to be a customer of the company. In addition, an MI attack is not limited to such an example, and yet another attack may be made.

The learning apparatus 10 in the present disclosure generates a further machine learning model by using a technique called distillation in order to cope with an attack on a pre-learned machine learning model as described above. For this reason, the learning apparatus 10 further includes the following configuration.

The first training data generating unit 12 generates first training data, which is training data used for distillation, based on unlabeled training data having been prepared. The unlabeled training data used here is stored in advance in the storing unit connected to the learning apparatus 10. The unlabeled training data may be data different from the pre-training data, or may be data including only explanatory variables obtained by excluding target variables from the pre-training data. It is known that a machine learning model having tolerance to an MI attack and high inference precision is generated by thus performing machine learning based on the first training data.

For example, the first training data generating unit 12 generates first training data including target variables by inputting unlabeled training data different from the pre-training data as explanatory variables to one pre-learned machine learning model having been learned using the pre-training data, and adding a score vector composed of the values of a plurality of elements output at the time as the target variables of the input unlabeled training data. That is to say, the first training data generating unit 12 generates first training data such that (unlabeled training data (explanatory variables) and a score vector (target variables)).

The first training data generating unit 12 can also generate the first training data by using a plurality of pre-learned machine learning models. For example, by dividing the pre-training data into k (k is an integer greater than or equal to 2), k sets of division data are generated, and k pre-learned machine learning models are generated by machine learning using data excluding one set of division data from the pre-training data and are stored in advance in the pre-learned machine learning model storing unit 11. Then, using data obtained by excluding the target variables of the pre-training data as unlabeled training data, the first training data generating unit 12 inputs data having not been used for learning a pre-learned machine learning model i as an explanatory variable, and adds a score vector that is an output by the pre-learned machine learning model i as a label (target variable) to the explanatory variable. The first training data is generated by integrating the k sets of data thus obtained.

The second training data generating unit 13 generates second training data used for machine learning of a machine learning model along with the first training data for the purpose of increasing the tolerance to an MI attack of a machine learning model in learning. The second training data generating unit 13 generates the second training data by changing the values of elements of a score vector that is the target variable of the first training data generated by the first training data generating unit 12. Herein, the target variable of the first training data is not localized to a certain element of the vector because the output vector of the pre-learned machine learning model is used as it is, and the learning proceeds in the direction of the correct label mistakenly in the process of the learning in which the learning has not converged. In order to solve this, the second training data generating unit 13 changes the target variable of the first training data to a vector in which the value of a certain element is prominent. At this time, the second training data generating unit 13 may transform the values of all the elements of the target variable of the first training data, or may transform the values of only some of the elements of the target variable of the first training data.

For example, the second training data generating unit 13 replaces an element with the greatest value of a target variable y=(y₁, . . . , yₙ) of the first training data with “1” and the other elements with “0” to generate a target variable y′=(y₁′, . . . , yₙ′) shown in Equation 1 below. Herein, n denotes an integer greater than or equal to 2, which represents the number of classes of the currently considered classification problem.

$${{y}^{′}}_{i} = \{ \begin{matrix}1 & ( i = arg {max}_{j} {y}_{j} ) \\ 0 & ( i \neq arg {max}_{j} {y}_{j} )\end{matrix} \qquad [ Equation 1 ]$$

The second training data generating unit 13 may replace not only an element with the greatest value of the target variable of the first training data, but also only the top m (m is an integer greater than or equal to 2) elements with the greatest values with a finite value (a value greater) than “0”) and replace the other elements with “0”. For example, if m=2, the second training data generating unit 13 replaces only two elements with “0.5” each, and replaces the other elements with “0”.

Further, the target variable y=(y₁, . . . , yₙ) for the explanatory variable x of the first training data is expressed as y=(F(x)₁, . . . , F(x)ₙ) as the output of a certain machine learning model F. The machine learning model F applies the softmax function at the end. If the output of the machine learning model F for the input x before application of the softmax function is z, the final output of the machine learning model F is F(x)=softmax(z/T) by introducing a temperature parameter T. The first training data generating unit 12 usually sets T=1. By making this temperature parameter smaller than 1, the second training data generating unit 13 can generate the second training data in which the target variable is a vector localized to an element with the largest value. At this time, the elements other than the element with the largest value also take positive values that are not 0.

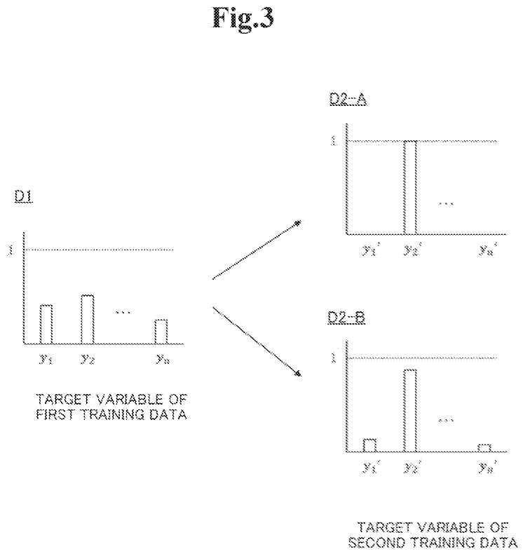

FIG. 3 shows a conceptual diagram of the two types of second training data generation methods described above. Reference character D1 in FIG. 3 indicates the target variable of the first training data, and reference characters D2-A and D2-B indicate examples of the target variable of the second training data generated from the target variable of the first training data. Reference character D2-A is an example in which the second training data is generated by replacing an element with the largest value of the target variable of the first training data with “1” and the other elements with “0”. Reference character D2-B is an example in which the second training data is generated by setting an element with the largest value of the target variable of the first training data as the maximum value and replacing the other elements with positive values that are not 0.

Thus, the second training data generating unit 13 generates the second training data in which the values of the respective elements of the vector that is the target variable of the first training data are set so that a relative magnitude difference in values between at least some elements is larger. Moreover, in other words, the second training data generating unit 13 generates the second training data in which the values of the respective elements of the vector that is the target variable of the first training data are set so that the difference in values between at least one of the elements with large values as compared with the other elements and the other elements is larger in accordance with a preset criterion (for example, the top m elements). In particular, the second training data generating unit 13 preferably generates the second training data in which the values of the respective elements of the vector that is the target variable of the first training data are set so that the value of an element with the largest value is the largest and the difference in value from the other elements is larger. As an example, the second training data generating unit 13 generates the second training data by setting the values of the respective elements of the vector that is the target variable of the first training data so that the value of an element with the largest value is a value greater than 0, for example, 1 and the values of the other elements are 0 or a value close to 0. Meanwhile, the second training data generation method by the second training data generating unit 13 is not limited to the method as described above.

The learning unit 14 generates a machine learning model by machine learning based on the first training data and the second training data. In machine learning, for example, optimization of the parameter of each layer in a deep learning model is performed. Thus, a machine learning model is generated. In this example embodiment, by using not only the first training data but also the second training data described above, a machine learning model which is tolerant to an MI attack even during learning is generated.

For example, the learning unit 14 presets a parameter a indicating the usage ratio of the second training data to the first training data, where α is a real number between 0 and 1, inclusive. A loss function at the time of learning using the first training data is L₀. A loss function at the time of learning using the second training data is L₁. For example, the learning unit 14 calculates a loss function L_{α} based on the following Equation 2.

$${L}_{α} = ( 1 - α ) {L}_{0} + α {L}_{1} \qquad [ Equation 2 ]$$

The learning unit 14 performs machine learning based on the loss function L_{α}. That is to say, the learning unit 14 performs machine learning so as to make the loss function L_{α} small. When it is desired to enhance safety during learning, α is made to be large. On the contrary, when α is 0, the second training data is not to be used, and therefore, it is desired that the α be greater than 0.

Thus, in this example embodiment, the second training data generating unit 13 generates he second training data by transforming the target variable of the first training data generated by using the score vector of the machine learning model stored in the pre-learned machine learning model storing unit 11 in the first training data generating unit 12 into a vector in which an element with the largest value is prominent. By performing machine learning based on the second training data in addition to the first training data, the learning unit 14 can proceed with learning in a direction with a tolerance to an MI attack even during learning.

### [Operation]

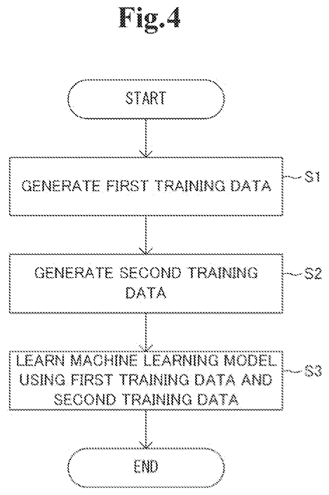

Next, a learning method according to this example embodiment will be described with reference to FIG. 4. FIG. 4 is a flowchart showing the operation of the learning apparatus in this example embodiment.

First, the first training data generating unit 12 generates the first training data by adding the score vector by the machine learning model stored in the pre-learned machine learning model storing unit 11 as a label to the unlabeled training data (step S1).

Next, the second training data generating unit 13 generates the second training data by transforming the target variable of the first training data to a vector in which an element with the largest value is prominent (step S2). Specifically, the second training data generating unit 13 generates the second training data in which an element with the largest value of the target variable of the first training data is set to “1” and the other elements are set to “0” based on Equation 1 described above, for example. The second training data generating unit 13 can also generate the second training data by changing the temperature parameter of the softmax function to a lower temperature than 1.

Finally, the learning unit 14 generates a machine learning model by machine learning based on the first training data and the second training data. For example, the learning unit 14 performs machine learning so as to decrease the loss function L_{α} calculated based on Equation 2 described above, for example.

Thus, in this example embodiment, the second training data generating unit 13 generates the second training data by setting the target variable of the first training data generated by the first training data generating unit 12 using the score vector by the pre-learned machine learning model so that a relative magnitude difference in value between at least some of the elements becomes larger and, for example, transforming the target variable to a vector in which an element with the largest value is more prominent than the other elements. Then, the learning unit 14 performs machine learning based on the second training data in addition to the first training data, so that learning can be advanced in a direction tolerant to an MI attack even during learning.

### Second Example Embodiment

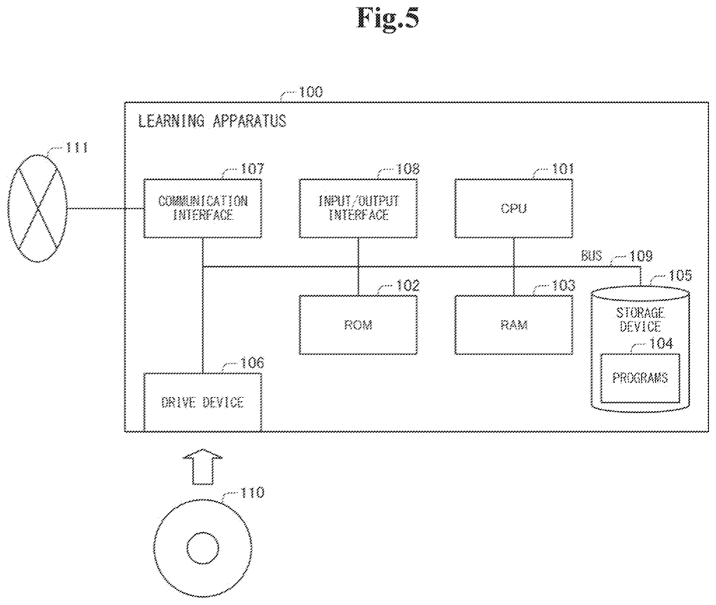

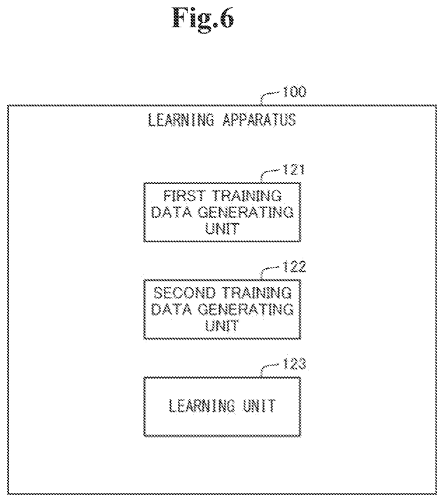

Next, a second example embodiment of the present disclosure will be described with reference to FIGS. 5 and 6. FIGS. 5 and 6 are block diagrams showing the configuration of a learning apparatus in the second example embodiment. In this example embodiment, the overview of the configuration of the learning apparatus described in the above example embodiment will be shown.

First, the hardware configuration of a learning apparatus 100 in this example embodiment will be described with reference to FIG. 5. The learning apparatus 100 is configured by a general information processing apparatus and has, as an example, a hardware configuration as shown below including
a CPU (Central Processing Unit) 101 (arithmetic logic unit),
a ROM (Read Only Memory) 102 (memory unit),
a RAM (Random Access Memory) 103 (memory unit),
programs 104 loaded to the RAM 103,
a storage device 105 storing the programs 104,
a drive device 106 reading from and writing into a storage medium 110 outside the information processing apparatus,
a communication interface 107 connected to a communication network 111 outside the information processing apparatus,
an input/output interface 108 performing input/output of data, and
a bus 109 connecting the respective components.

FIG. 5 shows an example of the hardware configuration of the information processing apparatus serving as the learning apparatus 100. The hardware configuration of the information processing apparatus is not limited to the abovementioned case. For example, the information processing apparatus may include part of the abovementioned configuration, such as excluding the drive device 106. In addition, instead of the CPU described above, the information processing apparatus can include a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof.

Then, the learning apparatus 100 can include a first training data generating unit 121, a second training data generating unit 122, and a learning unit 123 shown in FIG. 6, which are constructed by acquisition and execution of the programs 104 by the CPU 101. The programs 104 are, for example, stored in the storage device 105 or the ROM 102 in advance, and loaded to the RAM 103 and executed as necessary by the CPU 101. The programs 104 may be supplied to the CPU 101 via the communication network 111, or may be stored in the storage medium 110 in advance and retrieved and supplied to the CPU 101 by the drive device 106. Meanwhile, the first training data generating unit 121, the second training data generating unit 122, and the learning unit 123 described above may be constructed with a dedicated electronic circuit for realizing such means.

The first training data generating unit 121 generates first training data in which a vector composed of the values of a plurality of elements output by inputting unlabeled training data to a pre-learned machine learning model is a target variable. The second training data generating unit 122 generates second training data in which the values of the respective elements of the vector, which is the target variable of the first training data, are set so that a relative magnitude difference in values between at least some of the elements becomes larger. The learning unit 123 generates a machine learning model by machine learning using the first training data and the second training data.

According to the present disclosure, with the configuration as described above, second training data is generated from first training data in which a vector that is the output of a pre-learned machine learning model is a target variable, by setting the target variable so that a relative magnitude difference in values between at least some of the elements becomes larger and, for example, transforming the target variable to a vector in which an element with the largest value is more prominent than the other elements. Then, by performing machine learning based on the second training data in addition to the first training data, a machine learning model that is tolerant to an MI attack even during learning can be generated, and information leakage can be inhibited.

The abovementioned program can be stored using various types of non-transitory computer-readable mediums and supplied to a computer. The non-transitory computer-readable mediums include various types of tangible storage mediums. Examples of the non-transitory computer-readable mediums include a magnetic recording medium (e.g., a flexible disk, a magnetic tape, a hard disk drive), a magneto-optical recording medium (e.g., a magneto-optical disk), a CD-ROM (Read Only Memory), a CD-R, a CD-R/W, and a semiconductor memory (e.g., a mask ROM, a PROM (Programmable ROM), an EPROM (Erasable PROM), a Flash ROM, a RAM (Random Access Memory)). The program may also be supplied to a computer by various types of transitory computer-readable mediums. Examples of the transitory computer-readable mediums include an electrical signal, an optical signal, and an electromagnetic wave. The transitory computer-readable medium can supply the program to a computer via a wired communication path such as an electric wire and an optical fiber, or a wireless communication path.

Although the present disclosure has been described above with reference to the example embodiments and so forth, the present disclosure is not limited to the above example embodiments. The configurations and details of the present disclosure can be changed in various manners that can be understood by one skilled in the art within the scope of the present disclosure. Moreover, at least one or more of the functions of the first training data generating unit 121, the second training data generating unit 122, and the learning unit 123 described above may be executed by an information processing apparatus installed and connected at any location on the network, that is, may be executed using so-called cloud computing.

### Supplementary Notes

The whole or part of the example embodiments disclosed above can be described as the following supplementary notes. The overview of the configurations of the learning apparatus, the learning method, and the program in the present disclosure will be described below. Meanwhile, the present disclosure is not limited to the following configurations.

### (Supplementary Note 1)

A learning apparatus comprising:
a first training data generating unit configured to generate first training data with a vector as a target variable, the vector including values of a plurality of elements output by inputting unlabeled training data to a pre-learned machine learning model:
a second training data generating unit configured generate second training data in which the values of the elements of the vector as the target variable of the first training data are set so that a difference in magnitude of value between at least some of the elements becomes larger; and
a learning unit configured to generate a machine learning model by machine learning using the first training data and the second training data.

### (Supplementary Note 2)

The learning apparatus according to Supplementary Note 1, wherein
the second training data generating unit is configured to generate the second training data in which the values of the elements of the vector as the target variable of the first training data are set so that a difference in value between at least one of the elements that has a large value as compared with others of the elements by a preset criterion and another of the elements becomes larger.

### (Supplementary Note 3)

The learning apparatus according to Supplementary Note 1 or 2, wherein
the second training data generating unit is configured to generate the second training data in which the values of the elements of the vector as the target variable of the first training data are set so that a value of an element that has a largest value becomes largest and a difference in value between the element and others of the elements becomes larger.

### (Supplementary Note 4)

The learning apparatus according to any of Supplementary Notes 1 to 3, wherein
the second training data generating unit is configured to generate the second training data by setting, among the values of the elements of the vector as the target variable of the first training data, a value of an element that has a largest value to a value greater than 0 and values of elements other than the element to 0.

### (Supplementary Note 5)

The learning apparatus according to any of Supplementary Notes 1 to 4, wherein
the second training data generating unit is configured to generate the second training data by setting a value of a temperature parameter of softmax function to a value smaller than 1, the softmax function being used for generation of the vector as the target variable of the first training data.

### (Supplementary Note 6)

The learning apparatus according to any of Supplementary Notes 1 to 5, wherein
the learning unit is configured to generate the machine learning model by machine learning using the second training data in a preset ratio to the first training data.

### (Supplementary Note 7)

The learning apparatus according to Supplementary Note 6, wherein:
a loss function L_{α} is calculated by L_{α}=(1−α)L₀+αL₁, where a parameter indicating the ratio of the second training data to the first training data is α, a loss function in machine learning using the first training data is L₀, and a loss function in machine learning using the second training data is L₁; and
the machine learning model is generated based on the loss function L_{α}.

### (Supplementary Note 8)

A learning method comprising:
generating first training data with a vector as a target variable, the vector including values of a plurality of elements output by inputting unlabeled training data to a pre-learned machine learning model;
generating second training data in which the values of the elements of the vector as the target variable of the first training data are set so that a difference in magnitude of value between at least some of the elements becomes larger; and
generating a machine learning model by machine learning using the first training data and the second training data.

### (Supplementary Note 9)

A program comprising instructions for causing a computer to execute processes to:
generate first training data with a vector as a target variable, the vector including values of a plurality of elements output by inputting unlabeled training data to a pre-learned machine learning model;
generate second training data in which the values of the elements of the vector as the target variable of the first training data are set so that a difference in magnitude of value between at least some of the elements becomes larger; and
generate a machine learning model by machine learning using the first training data and the second training data.

### DESCRIPTION OF REFERENCE NUMERALS

10 learning apparatus
11 pre-learned machine learning model storing unit
12 first training data generating unit
13 second training data generating unit
14 learning unit
100 learning apparatus
101 CPU
102 ROM
103 RAM
104 programs
105 storage device
106 drive device
107 communication interface
108 input/output interface
109 bus
110 storage medium
111 communication network
121 first training data generating unit
122 second training data generating unit
123 learning unit

1. A learning apparatus comprising:
at least one memory configured to store processing instructions; and
at least one processor configured to execute the processing instructions to:
generate first training data with a vector as a target variable, the vector including values of a plurality of elements output by inputting unlabeled training data to a pre-learned machine learning model;
generate second training data in which the values of the elements of the vector as the target variable of the first training data are set so that a difference in magnitude of value between at least some of the elements becomes larger; and
generate a machine learning model by machine learning using the first training data and the second training data.

2. The learning apparatus according to claim 1, wherein the at least one processor is configured to execute the processing instructions to
generate the second training data in which the values of the elements of the vector as the target variable of the first training data are set so that a difference in value between at least one of the elements that has a large value as compared with others of the elements by a preset criterion and another of the elements becomes larger.

3. The learning apparatus according to claim 1, wherein the at least one processor is configured to execute the processing instructions to
generate the second training data in which the values of the elements of the vector as the target variable of the first training data are set so that a value of an element that has a largest value becomes largest and a difference in value between the element and others of the elements becomes larger.

4. The learning apparatus according to claim 1, wherein the at least one processor is configured to execute the processing instructions to
generate the second training data by setting, among the values of the elements of the vector as the target variable of the first training data, a value of an element that has a largest value to a value greater than 0 and values of elements other than the element to 0.

5. The learning apparatus according to claim 1, wherein the at least one processor is configured to execute the processing instructions to
generate the second training data by setting a value of a temperature parameter of softmax function to a value smaller than 1, the softmax function being used for generation of the vector as the target variable of the first training data.

6. The learning apparatus according to claim 1, wherein the at least one processor is configured to execute the processing instructions to
generate the machine learning model by machine learning using the second training data in a preset ratio to the first training data.

7. The learning apparatus according to claim 6, wherein the at least one processor is configured to execute the processing instructions to:
calculate a loss function L_{α} by L_{α}=(1−α)L₀+αL₁, where a parameter indicating the ratio of the second training data to the first training data is α, a loss function in machine learning using the first training data is L₀, and a loss function in machine learning using the second training data is L₁; and
generate the machine learning model based on the loss function L_{α}.

8. A learning method comprising:
generating first training data with a vector as a target variable, the vector including values of a plurality of elements output by inputting unlabeled training data to a pre-learned machine learning model;
generating second training data in which the values of the elements of the vector as the target variable of the first training data are set so that a difference in magnitude of value between at least some of the elements becomes larger; and
generating a machine learning model by machine learning using the first training data and the second training data.

9. The learning method according to claim 8, comprising
generating the second training data in which the values of the elements of the vector as the target variable of the first training data are set so that a difference in value between at least one of the elements that has a large value as compared with others of the elements by a preset criterion and another of the elements becomes larger.

10. The learning method according to claim 8, comprising
generating the second training data in which the values of the elements of the vector as the target variable of the first training data are set so that a value of an element that has a largest value becomes largest and a difference in value between the element and others of the elements becomes larger.

11. The learning method according to claim 8, comprising
generating the second training data by setting, among the values of the elements of the vector as the target variable of the first training data, a value of an element that has a largest value to a value greater than 0 and values of elements other than the element to 0.

12. The learning method according to claim 8, comprising
generating the second training data by setting a value of a temperature parameter of softmax function to a value smaller than 1, the softmax function being used for generation of the vector as the target variable of the first training data.

13. The learning method according to claim 8, comprising
generating the machine learning model by machine learning using the second training data in a preset ratio to the first training data.

14. The learning method according to claim 13, comprising:
calculating a loss function L_{α} by L_{α}=(1−α)L₀+αL₁, where α is a parameter indicating the ratio of the second training data to the first training data, L₀ is a loss function in machine learning using the first training data, and L₁ is a loss function in machine learning using the second training data; and
generating the machine learning model based on the loss function L_{α}.

15. A non-transitory computer-readable storage medium storing a program, the program comprising instructions for causing a computer to execute processes to:
generate first training data with a vector as a target variable, the vector including values of a plurality of elements output by inputting unlabeled training data to a pre-learned machine learning model;
generate second training data in which the values of the elements of the vector as the target variable of the first training data are set so that a difference in magnitude of value between at least some of the elements becomes larger; and
generate a machine learning model by machine learning using the first training data and the second training data.
